(19) United States
(12) Patent Application Publication
(10) Pub. No.: US 2001/0021639 A1
(43) Pub. Date: Sep. 13, 2001

(54) Radio communications system, radio communications method and radio communications device used in a radio communications system

(76) Inventor: Takashi Kaku, Kawasaki (JP)

Correspondence Address: HELFGOTT & KARAS, P.C., EMPIRE STATE BUILDING, 60TH FLOOR, NEW YORK, NY, 10118, US

(21) Appl. No.: 09/773,321

(22) Filed: Jan. 31, 2001

(30) Foreign Application Priority Data
Mar. 8, 2000 (JP) 2000-063760

(51) Int. Cl. H04B 5/00

(52) U.S. Cl. 455/41; 455/448

(57) ABSTRACT

A radio network is composed of a plurality of communications chips. The communications areas of the communications chips overlap one another. A gateway connects the radio network to another network and manages the radio network. When a radio signal is transmitted from a terminal device, each communications chip generates and outputs a corresponding radio signal in order that the signal level of the radio signal becomes a prescribed level. In this way, radio signals transmitted from a terminal device are propagated all over the area of the radio network.

### Background of the Invention

1. Field of the Invention

The present invention relates to a radio communications system and in particular relates to a technology to implement a high-speed radio access network.

2. Description of the Related Art

With the penetration of informationalization in a variety of fields, a demand for an increase in speed of data transmission and the utility of portable terminal devices has been increased. Along with this trend, cellular phones have explosively spread and a high data transmission rate has been implemented. As for indoor (for example, in homes and offices) radio data communications technologies, a radio LAN, which is a typical embodiment of IEEE802.11, Bluetooth, which is expected to rapidly spread, etc., has been put into practical use.

A radio LAN stipulated in IEEE802.11 uses a 2.4 GHz band as a carrier frequency and the maximum data transmission rate is 2 Mbps. In IEEE802.11a, a radio LAN using a 5 GHz band as a carrier frequency is now under study, and in IEEE802.11b, a radio LAN with a maximum data transmission rate of 11 Mbits/sec. is also under study. The maximum transmission distance of this radio LAN is 100 meters (30 meters in the case of IEEE802.11b).

Bluetooth uses a 2.4 GHz band as a carrier frequency and the maximum data transmission rate is 1 Mbps. As the transmitting output power of a radio wave, three classes (class1: +20 dBm, class2: +4 dBm and class3: 0 dBm) are stipulated and the maximum transmission distance is 10 to 100 meters.

In this way, a radio communications system has been put into practical use and has spread as an access system.

However, the radio communications- system described above has problems to be solved. For example, in a radio LAN, the influence of a multi-path increases as the transmission rate increases. Therefore, unless there is a technological breakthrough, it is difficult to implement a high-speed transmission rate of around 100 Mbps. In a radio LAN, a base station is required. The base station equipment used in a radio LAN is often installed, for example, on a ceiling, on a desk in an office, etc. In this case, some installation work is required to install the base station equipment and there is the possibility of spoiling the office environment. If the base station equipment is to be installed on a desk, sometimes it is difficult to secure a space for it.

With Bluetooth, the number of terminal devices that can be used for each master device is 7 and sometimes data cannot be transmitted/received in an environment where there are many terminal devices in a small area. To solve this problem, a configuration called a “scatter-net” has been proposed. With the scatter-net, the problem has been solved by closely installing pico-nets, each of which is managed by a corresponding master device, and by enabling each terminal device to access arbitrary master device. However, in this scatter-net, a plurality of master devices must be provided. Therefore, in terms of cost and installation space, there is an increase in overhead. In addition, when a mobile terminal moves from the communications area of a specific master device to the communications area of another master device, hand-over (hand-off) or roaming is sometimes required.

As described above, in a conventional radio communications system of access line, a data transmission rate is not sufficiently high. In addition, a space to install communications equipment must be secured and it is difficult to introduce such a system in a short period of time.

### SUMMARY OF THE INVENTION

It is an object of the present invention to provide a high-speed radio communications system. It is another object of the present invention to provide a radio communications system that does not require a space to install communications equipment and that can be established in a very short period of time.

The radio communications system of the present invention includes a plurality of radio communications devices. Each radio communications device can be a chip in form or can be accommodated in a housing, etc. Each radio communications device comprises a receiving unit receiving a radio signal; a detector detecting a difference level between a predetermined reference level and the receiving level of the radio signal received by the receiving unit; and a transmitting unit outputting a radio signal, which is same signal as that received by the receiving unit, at a transmitting level such that the difference level detected by the detector is zero.

If a radio signal is transmitted from a terminal device accommodated in the system, the radio signal is received by one or more radio communications devices. Then, on receipt of the radio signal, each radio communications device detects the difference level between the receiving level and reference level and outputs the same radio signal as that received, at that difference level. In this way, in the vicinity of each radio communications device that has received the radio signal transmitted from the terminal device, the signal level of the radio signal is equal to the reference level.

A radio signal generated by a specific radio communications device is received by other radio communications devices in a same manner. Then, on receipt of the generated radio signal, each radio communications device outputs the radio signal in the same way as the radio communications device that has received the radio signal directly from the terminal device. In this way, in the vicinity of this radio communications device too, the signal level of the radio signal becomes equal to the reference level.

The operation described above is performed by each of the radio communications devices. In this way, radio signal from a terminal device is transmitted all over the area of a radio communications system.

In this system, the detector can also be provided with an integrator for performing a complete integral on the difference between the reference level and receiving level and the transmitting unit outputs a radio signal based on the output of the integrator. According to this configuration, the signal level of the radio signal can be precisely matched with the reference level.

In addition, the system can comprise a judgment unit stopping the operation of the transmitting unit if the receiving level of the radio signal from a terminal device or another radio communications device is lower than a predetermined threshold value. According to this configuration, if a terminal device stops transmitting a radio signal, the transmission of radio signal is also stopped over the entire area of the radio communications system.

Furthermore, the system can also comprise a power generator generating power using at least one of temperature, light, noise and vibration (in particular, electromagnetic noise radiated by a fluorescent lamp or ripples put on AC voltage supplied to a fluorescent lamp) in the vicinity of the relevant radio communications device and power generated by the power generator is supplied to at least one of the receiving unit, detector and transmitting unit. According to this configuration, there is no need to provide each radio communications device with a battery and neither is a feeder required for supplying power to each radio communications device.

### BRIEF DESCRIPTIONS OF THE DRAWINGS

FIG. 1 shows how the radio communications system of the present invention is used.

FIG. 2 shows the configuration of the radio communications system in one embodiment of the present invention.

FIG. 3 shows an example of the radio communications system in use.

FIG. 4 shows a space-shared bus used to transmit radio signals.

FIG. 5 shows an operation for each communications chip to compensate for the signal level of a radio signal.

FIG. 6 shows an operation to generate radio signals taking into consideration the influence of radio signals generated by another communications chip.

FIG. 7 shows a fluorescent lamp with a communications chip built in.

FIG. 8 shows the configuration of a communications chip.

FIG. 9 is the circuit diagram of a signal generation unit.

FIG. 10 is the circuit diagram of an integrator.

FIG. 11 shows the operation of a signal generation unit.

FIG. 12 is the circuit diagram of a power generation unit.

FIGS. 13A-13C show the operation of a power generation unit.

FIG. 14 shows the configuration of a communications chip provided with a circuit for eliminating common-mode noise.

FIG. 15 is a sequence chart showing an operation of a gateway to allocate communications channels to terminal devices (No. 1).

FIG. 16 is a sequence chart showing an operation of a gateway to allocate communications channels to terminal devices (No. 2).

FIG. 17 shows a communications channel management table.

FIG. 18A shows how a plurality of radio signals are composed.

FIG. 18B shows data provided with a guard interval.

### DESCRIPTION OF THE PREFERRED EMBODIMENTS

The embodiments of the present invention are described with reference to the drawings.

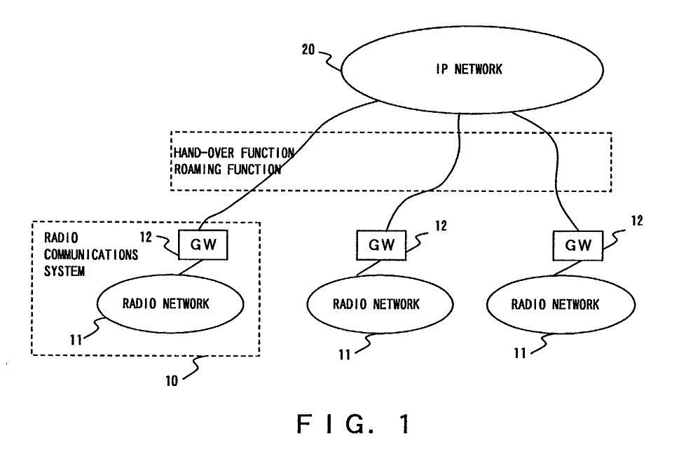

FIG. 1 shows how the radio communications system of the present invention is used. The radio communications system 10 of the present invention comprises a radio network (sub-net) 11 and a gateway 12 for connecting the radio network 11 to another network. The communications area of the radio network 11 is fairly small and the radius is, for example, 100 meters or less. Therefore, if a LAN, etc., is established in an office occupying a plurality of floors, it is preferable to provide each floor with a radio communications system 10.

The gateway 12 connects the radio network 11 to an IP network 20. The connection between the radio network 11 and the IP network 20 has been implemented by a known art (TCP/IP protocol, etc.). Although in the example shown in FIG. 1, a plurality of radio networks 11 are connected to one another via the IP network 20, the connection between the radio networks 11 is not always made via the IP network 20. For example, the gateways 12 may be connected to one another using a dedicated line, etc., and the plurality of radio networks 11 may be connected via the dedicated line. In addition, although in the example shown in FIG. 1, the radio communications system 10 is connected to the IP network 20, it can also be connected to another network. For example, the radio communications system 10 can also be connected to a public network or WAN (Wide Area Network).

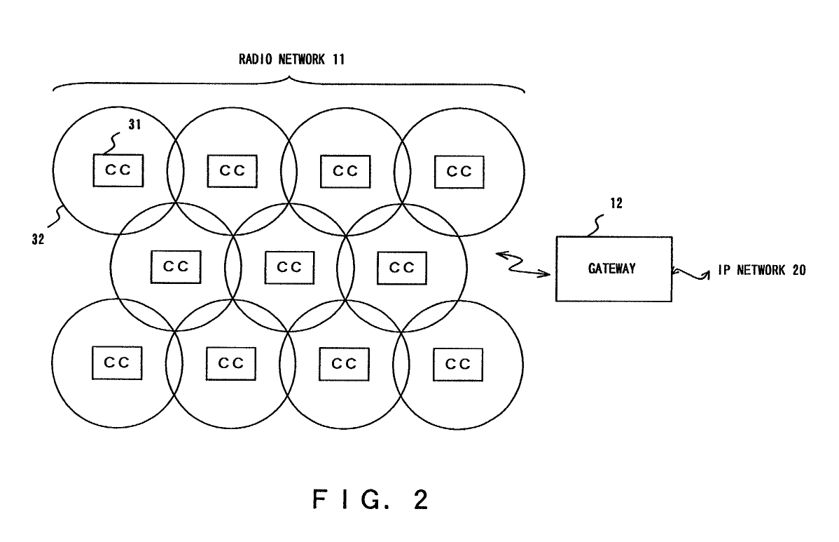

FIG. 2 shows the configuration of the radio communications system 10. The radio network 11 of the radio communications system 10 is implemented by a plurality of communications chips (CC) 31. Each communication chip 31 has a function to compensate for the signal level of radio signal. The communications chips 31 are installed, for example, at intervals of several meters. The radius of the communication area of a pico-net 32 (which corresponds to the “pico-net” of Bluetooth, etc.) generated by each communications chip 31 is, for example, approximately 10 meters. The radio network 11 is established by overlapping the communications areas of closely located pico-nets 32.

The communications area of each pico-net 32 is very small as described above. Therefore, the power of a radio signal transmitted within each pico-net 32 can be greatly reduced. For example, a level such that it cannot be the target of a variety of regulations related to radio communications, is assumed.

The transmission capacity of a network is determined by transmission bandwidth and S/N ratio. However, since currently there remains almost no idle frequency, it is difficult to broaden the transmission bandwidth. In addition, since a variety of the regulations are severe, it is difficult to increase transmitting power and it is also not easy to improve S/N ratio.

Therefore, in the system of this embodiment, high-speed transmission is implemented by dividing a radio network 11 into a plurality of pico-nets 32 with a very small communications area. If a communications area is small, a fairly broad transmission band can be secured, although a high S/N ratio cannot be secured since a signal must be weak within the area. For example, in a band area of 300 MHz or less, a broad band of 0 to 300 MHz can be used. In a band area of 150 GHz or more, an endless band can be used. However, in a band area of 300 MHz to 150 GHz, a weaker radio signal must be used to avoid interference with another radio signal. Currently, a band area of 0 to 300 MHz is assumed.

A “weak” signal is assumed to be a signal with power such that using of the signal is not restricted by regulations, etc. Therefore, inside a pico-net 32 where weak signals are used, there are few regulations on an available frequency and an arbitrary frequency can be freely used to some extent. In other words, within the communications area of a pico-net 32, abroad band can be secured and high-speed data transmission can be implemented accordingly. By closely locating a plurality of pico-nets 32 to one another, a high-speed radio network 11 can be implemented.

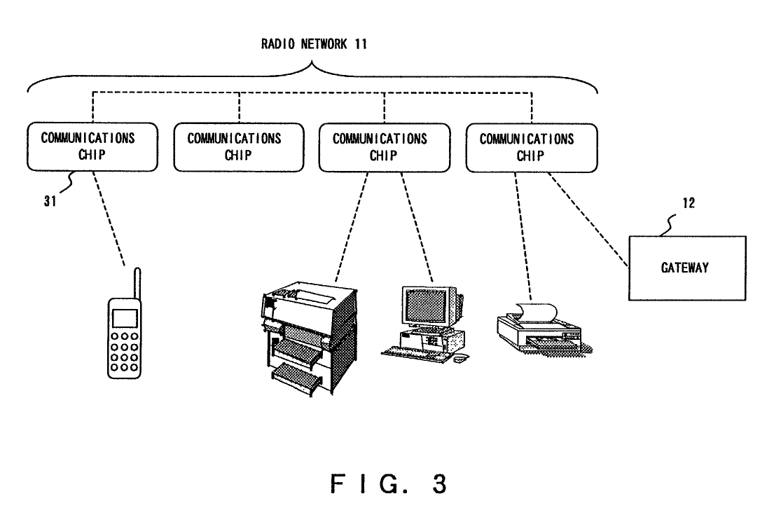

FIG. 3 shows an example of the radio communications system in use. FIG. 3showsacasewhere a radio communications system 10 is installed in an ordinary home or office.

The radio network 11 can accommodate a variety of terminal devices with a radio communications function. The terminal device includes a mobile communications terminal, such as a cellular phone, a PDA (Personal Digital Assistant), and a note-sized computer, a desk-top personal computer, a facsimile, a printer, a copy machine and a variety of other home electronic appliances. The gateway 12 is connected to the radio network 11 by a radio transmission line.

Data transmitted/received between the terminal devices are transmitted via the radio network 11. For example, when a command “print” is executed, a personal computer transmits an instruction to a printer via the radio network 11. If a terminal device is connected to another network (for example, the Internet), the terminal device is connected to an IP network via the gateway 12. In this case, the terminal device and gateway 12 are connected via the radio network 11.

As described above, each of a plurality of communications chips 31 composing the radio network 11 has a function to compensate for the signal level of radio signal. A space-shared bus used to transmit radio signals is formed by this function. In other words, the radio network 11 functions as a space-shared bus used to transmit radio signals.

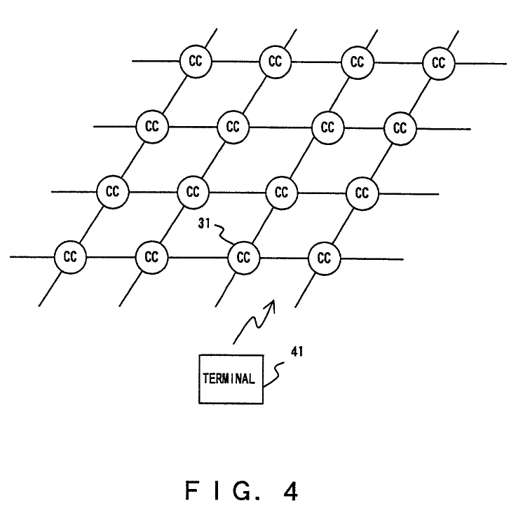

FIG. 4 shows a space-shared bus used to transmit radio signals. In FIG. 4, it is assumed that a radio signal is transmitted from a terminal device 41 and that the power of the radio signal is weak.

In the case described above, although the radio signal transmitted from the terminal device 41 reaches one or more communications chips in the vicinity of the terminal device 41, it cannot reach the other communications chips. In this case, on receipt of the radio signal transmitted from the terminal device 41, each communications chip detects the signal level of the radio signal (for example, amplitude or power). If the signal level of the received radio signal is lower than a prescribed signal level required by a network, each communications chip generates the same radio signal as that received and transmits the generated radio signal. In this case, the signal level of the radio signal generated by the communications chip is controlled such that the signal level of a radio signal in the vicinity of the relevant communications chip is a signal level required by the network. In other words, the communications chip that has received the radio signal compensates for the signal level of the radio signal in such a way to meet the requirements of the network.

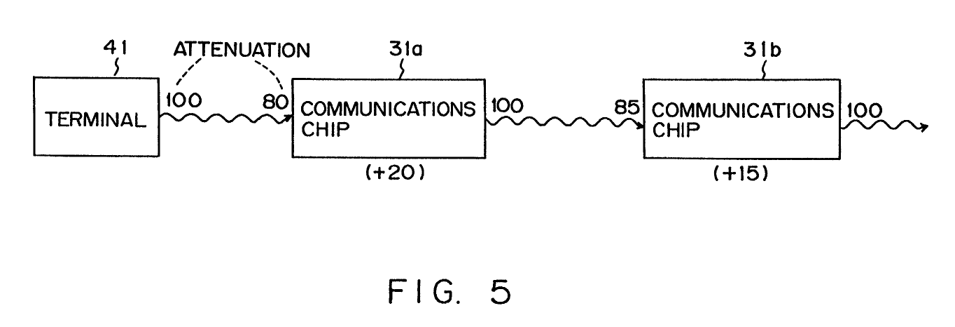

FIG. 5 shows an operation for each communications chip to compensate for the signal level of a radio signal. In this example, in order to simplify the description, it is assumed that communications chips are one-dimensionally located. It is also assumed that the signal level of a radio signal required by the radio network 11 (reference value) is “100”. Although this value indicates the amplitude or power of a radio signal, it is a value used only for descriptive purposes and the unit is not given here.

In FIG. 5 it is assumed that a terminal device 41 transmits a radio signal. In this case, it is assumed that the transmitting level of the terminal device 41 is “100”. The radio signal is received by a communications chip 31a. However, as well known, the radio signal is attenuated during transmission. In this example it is assumed that the receiving level of the communications chip 31b is “80”. In this case, the communications chip 31a generates and outputs the same signal as the received one. In this case, the transmitting level of a radio signal generated by the communications chip 31a is “20”. The radio signal outputted by the communications chip 31a is added to the radio signal generated by the terminal device 41. As a result, the signal level of the compound radio signal becomes “100”. In other words, the signal level of the radio signal transmitted from the terminal device 41 is compensated for by the communications chip 31a.

The radio signal compensated for by the communications chip 31a is received by a communications chip 31b. In this case, if the receiving level of the communications chip 31b is assumed to be “85”, the signal level of a radio signal generated and outputted by the communications chip 31b is “15”.

As described above, if in the radio network 11, a radio signal is transmitted from the terminal 41 (or gateway 12), the radio signal is propagated while the signal level is compensated for by each communications chip. In this way, the radio signal is transmitted all over the area of the radio network 11. In other words, the radio network 11 plays the role of a space-shared bus used to transmit the radio signal.

Although in FIG. 5, the signal level of a radio signal is calculated, for example, assuming that a radio signal transmitted from the terminal device 41 is received only by the communications chip 31a and that the communications chip 31a receives a radio signal only from the terminal device 41, this is simply for descriptive purposes and is not accurate. In other words, the radio signal transmitted from the terminal device 41 is actually received by a plurality of communications chips (in FIG. 5, communications chips 31aand31b). The communications chip 31a is to receive not only the radio signal directly from the terminal device 41, but also other radio signals generated by other communications chips (in FIG. 5, communications chip 31b).

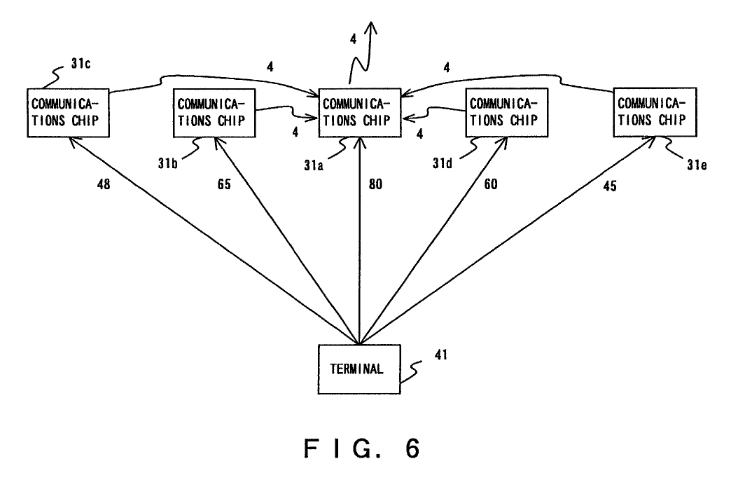

FIG. 6 shows an operation to generate radio signals, taking into consideration the influence of radio signals generated by another communications chip. In this example it is assumed that a radio network 11 includes five communications chips 31a-31e and that a terminal device 41 transmits a radio signal.

All the communications chips 31a-31e receive a radio signal transmitted from the terminal device 41. However, the respective receiving levels of the communications chips 31a-31e are different depending on the respective distances from the terminal device 41. As described above with reference to FIG. 5, on receipt of the radio signal, each of the communications chips 31a-31e generates and outputs a radio signal in order to compensate for the level of the radio signal.

Therefore, each of the communications chips 31a-31e receives not only the radio signal directly from the terminal device 41, but also the signals generated by other communications chips.

Here, attention is focussed on the communications chip 31a. It is assumed that the receiving level of the radio signal directly from the terminal device 41 is “80” and the receiving levels of the radio signals from communications chips 31b-31e are all “4”, respectively. In this case, the communication chip 31a detects “receiving level=96”.

Therefore, the communications chip 31a generates and outputs a signal with a “signal level=4”. In this way, the signal level of a radio signal in the vicinity of the communications chip 31a becomes “100”.

Similarly, this operation is also performed in each of the communications chips 31b-31e. Therefore, the level of a radio signal in the vicinity of each of the communications chip becomes almost equal to the reference level. As a result, the radio signal from the terminal device 41 is transmitted all over the area of the radio network 11.

Next, how to establish the radio network 11 is described.

When the radio network 11 is established, and in particular, when the radio network 11 is established in an indoor environment, such as an office, an ordinary home, etc., it is considered that usually a user has the following requirements.

(1) A space required to install communications equipment is small

(2) A network can be established in a short period of time

(3) Office environment is not spoiled

(4) Maintenance free

The radio communications system of this embodiment is designed to meet the requirements (1)-(4). Specifically, each communications chip 31 is designed and installed as follows.

(1) In order to reduce a space required to install communications equipment, the size of the communications chip 31 must be minimized. For a technology to minimize the size of a communications chip 31, a semiconductor fine-processing technology, a SiGe (Silicon-Germanium) technology, a SiGe inductor technology, etc., are used. In the field of fine processing, the wavelength shortening of laser beams has been advanced and a very fine circuit pattern can be formed on a semiconductor substrate. The SiGe inductor technology provides inductance elements, and this technology is currently attracting people's attention.

In this embodiment, since the radio network 11 consists of a plurality of small pico-nets, the transmitting power required by the radio network is very small. This fact greatly contributes to the miniaturization of the communications chip 31. The radio communications system of this embodiment is, as described above with reference to FIGS. 5 and 6, configured in such a way that each communications chip 31 detects the signal level of the radio signal and only compensates for the difference (shortage) between the signal level required by the radio network 11 and the signal level of the received signal. Therefore, the transmitting power of each communications chip is reduced, and this fact contributes to further miniaturization.

If the communications chip 31 is configured to be provided with only a basic function to implement the space-shared bus, a fairly simple circuit can implement the function. In this way, the communications chip 31 can be formed on a substrate of approximately 10-20 square millimeters by using the semiconductor fine-processing technology and SiGe inductor technology.

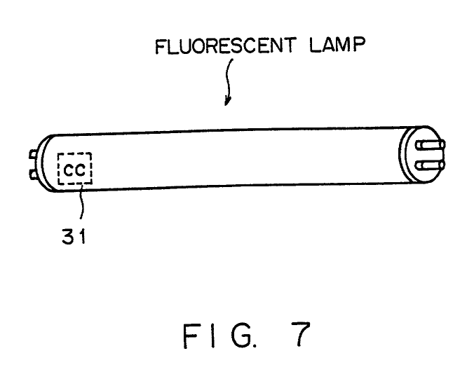

(2) The radio network 11 can be established in a short period of time by embedding the communications chip 31 miniaturized with a method of (1) in amass-consumed products which are used indoor. Here, one example of the mass-consumed products is a fluorescent lamp. In this case, for example, the communications chip 31 is built inside a fluorescent lamp, as shown in FIG. 7. In this case, in order to embed the communications chip 31 in a fluorescent lamp, it is preferable to use chip antennae as transmitting and receiving antennae. Since the communications chip 31 has a power generation function, which is described later, there is no need to connect the communications chip 31 to an external power supply via a feeder. Therefore, the communications chip 31 can be easily built inside the fluorescent lamp.

(3) The office environment can be secured by embedding the communications chip 31 in mass-consumed products as described in (2), even if communications equipment is installed in a room.

(4) In order to render the maintenance of the radio network 11 unnecessary or minimal, it is necessary for the communications chip 31 to operate without an external power supply or batteries. In order to achieve this objective, each communications chip 31 has a power generation function. A power generation function means to convert a variety of types of energy existed around a communications chip 31 into electric energy, which is implemented as follows.

(a) Using electromagnetic noise radiated by a fluorescent lamp

(b) Using ripples of AC power supply

(c) Using heat generated by a fluorescent lamp

(d) Using light of a fluorescent lamp

(e) Using environmental noise

(f) Using vibration of an object

Method (c) above can be implemented by a technology to convert the difference in temperature between the inside and outside of a fluorescent lamp into electric energy. For an example of this technology, a wristwatch, which operates by obtaining power from human temperature, has been put into a practical use. Method (d) above can be easily implemented by using solar cells. Method (e) above can be implemented by a technology to convert electromagnetic waves radiated by a variety of electric appliances into electric energy. Such environmental noise has increased every year and will be able to be used in the future. Method (f) above can be implemented by using a vibration LSI.

However, methods (c)-(f) have respective problems to be solved and are not necessarily recommended at present. Therefore, in this embodiment, a power generation function of methods (a) or (b) is adopted and described later.

High power cannot be expected from power generation function of methods (a)-(f). Therefore, the power consumption of the communications chip 31 must be reduced as much as possible. In order to achieve this objective, it is preferable to use technologies such as an SAW filter technology, a voltage-reducing technology (3.3v→1.8v→0.4v, . . .), etc., in addition to the fine-processing technology and SiGe inductor technology, in the design of the communications chip 31.

Furthermore, if the communications chip 31 uses some software, a soft-radio technology can be used to render the maintenance of the communications chip 11 unnecessary or minimal. A “soft-radio technology” means to distribute a software program from a server to a communications chip 31 via a radio transmission line.

In order to implement the soft-radio technology, for example, each communications chip 31 is provided with a rewritable memory, such as an EEPROM, a flash RAM, a highly dielectric memory (FRAM), a magnetic RAM (MRAM), etc., and basic communications software must be installed in advance in the communications chip 31. When the program installed in the communications chip 31 is updated, a new program is distributed to each communications chip 31 from a server connected to an IP network via a gateway 12 or directly from the gateway 12. According to this method, the radio network 11 can provide the services of the latest program without having to replace the communications chip 31.

Next, the configuration and operation of the communications chip 31 will be described.

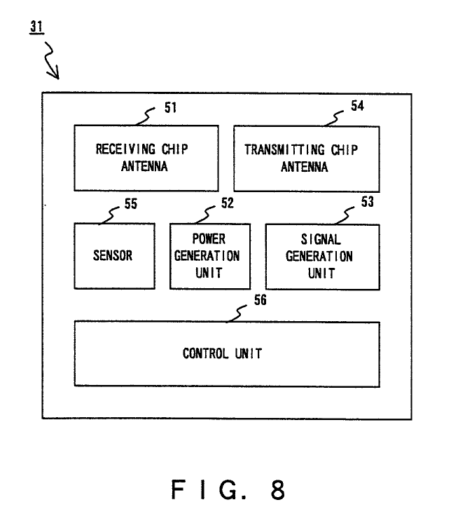

FIG. 8 shows the configuration of the communications chip 31. A receiving chip antenna 51 receives a radio signal. Specifically, the receiving chip antenna 51 receives a radio signal to be transmitted via the radio network 11 and simultaneously receives an electromagnetic wave radiated by a fluorescent lamp or an electro-magnetic wave of a ripple that is put on AC voltage supplied to a fluorescent lamp. A power generation unit 52 converts the electromagnetic wave received by the receiving chip antenna 51 into electric energy and outputs a prescribed voltage. Then, the power generated by the power generation unit 52 is supplied to a signal generation unit 53, a sensor 55 and a control unit 56.

The signal generation unit 53 analyzes the radio signal received by the receiving chip antenna 51 and generates a signal to compensate for the signal level (amplitude or power) of the radio signal.

The sensor 55, for example, is a voice sensor for detecting or recognizing a voice or an image sensor for detecting or recognizing an image. The control unit 56 controls the sensor 55 or another circuit by executing a program installed in advance or distributed from a server. The control unit 56 can provide the following autonomous operation functions. The autonomous operation functions include a function to reduce transmitting power when the power generation unit 52 cannot generate sufficient power, a function to stop self-operation when it is confirmed that an adjacent communications chip operates normally, a function to increase transmitting power when neighboring noise are large, a function to designate data transmission rate to a terminal device depending on the usage situations of communication bands, etc.

The sensor 55 and control unit 56 are not essential in the present invention, and the communications chip 31 can implement the space-shared bus described above without them.

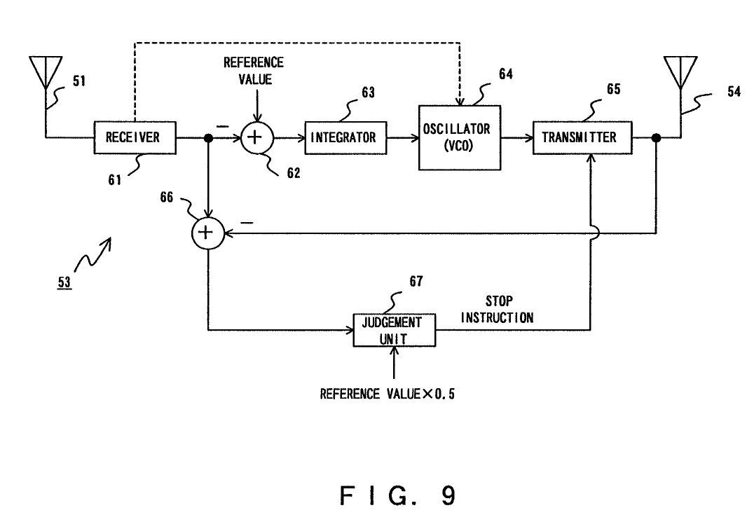

FIG. 9 is an example of the circuit diagram of the signal generation unit 53. A receiver 61 converts a radio signal received by the receiving chip antenna 51 into an electric signal and detects the phase of the radio signal. A calculator 62 calculates the difference between a predetermined reference value and the output of the receiver 61. In this example, the “reference value” indicates a signal level required by the radio network 11 and is determined in advance. The output of the receiver 61 corresponds to the signal level (receiving level) of the radio signal received by the receiving chip antenna 51. Therefore, the output of the calculator 62 corresponds to the difference between the signal level required by the radio network 11 and the receiving level of the radio signal.

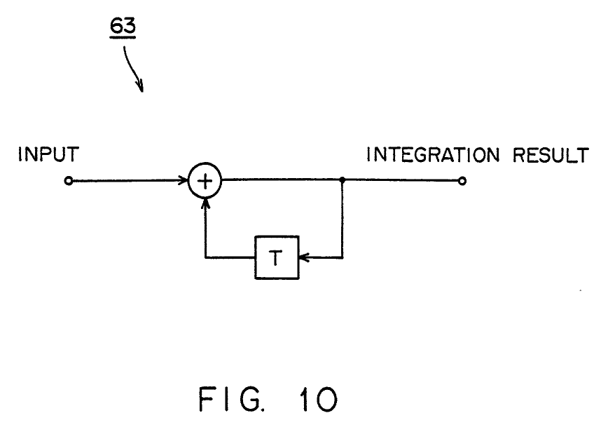

An integrator 63 is a complete integral circuit and performs a complete integral on the output of the calculator 62. Specifically, the integrator 63 performs a complete integral on the difference between the signal level required by the radio network 11 and the receiving level of the radio signal. The circuit shown in FIG. 10, for example, can be a complete integral circuit. As is well known, the complete integral circuit comprises an adder and a delay circuit and it generates an integral value by cumulatively adding an input signal to the output of the adder which provides a signal of immediately previous sample timing.

The integrator 63 integrates a vector signal. An integrator for integrating a vector signal can control both amplitude and phase of a signal. Specifically, the integrator 63 operates to obtain amplitude in order to compensate for the receiving level (receiving power) and simultaneously controls the phase so as to match the receiving phase with the transmitting phase.

An oscillator 64 includes a VCO (Voltage Control Oscillator) and an amplifier. The oscillator 64 generates a signal with an amplitude that is determined based on the output of the integrator 63. Specifically, the oscillator 64 generates a signal with an amplitude that is determined based on the difference between the signal level required by the radio network 11 and the receiving level of the radio signal. The phase of a signal generated by the VCO 64 is determined in relation to a phase detected by the receiver 61.

A transmitter 65 transmits a signal generated by the oscillator 64 in the air using a transmitting chip antenna 54. In this way, a radio signal with amplitude that is determined based on the difference between the signal level required by the radio network 11 and the receiving level of the radio signal is transmitted from the transmitting chip antenna 54.

As described above, the receiver 61, calculator 62, integrator 63, oscillator 64 and transmitter 65 constitute a feedback system for controlling the signal level of the radio signal. A radio signal such that the receiving level of the radio signal at the communications chip 31 can match the signal level required by the radio network 11, is generated and outputted by this feedback system. Since the integrator 63 provided in the feedback system is a complete integral circuit, the signal level of a radio signal in the vicinity of the communications chip 31 is exactly matched with the signal level required by the radio network 11.

The calculator 66 subtracts the output of the transmitter 65 from the output of the receiver 61. A radio signal received by the receiver 61 includes a radio signal generated by the relevant communications chip, that is, a radio signal generated by the transmitter 65. Therefore, the signal level of a radio signal that the communications chip 31 receives from the terminal device and other communications chips can be obtained by eliminating the radio signal generated by the transmitter 65 from the radio signal received by the receiver 61.

A judgment unit 67 compares the output of the calculator 66 with a “reference value×0.5” and gives an instruction to the transmitter 65 based on the result. This reference value is the value used in the calculator 62. Specifically, the judgment unit 67 judges whether the signal level of the radio signal that the communications chip 31 receives from the terminal device and other communications chips is higher than the half-value of the signal level required by the radio network 11. If the signal level of the radio signal is lower than “reference value×0.5”, the judgment unit 67 judges that the terminal device is not transmitting a radio signal and gives a stop instruction to the transmitter 65. If the signal level of the radio signal is higher than the “reference value×0.5”, the judgment unit 67 judges that the terminal device is transmitting a radio signal and gives an output instruction to the transmitter 65.

On receipt of the output instruction from the judgment unit 67, the transmitter 65 outputs a signal generated by the oscillator 64, while on receipt of a stop instruction, it stops the transmitting operation. In this way, if the terminal device stops transmitting signals, the communications chip 31 also stops transmitting radio signals.

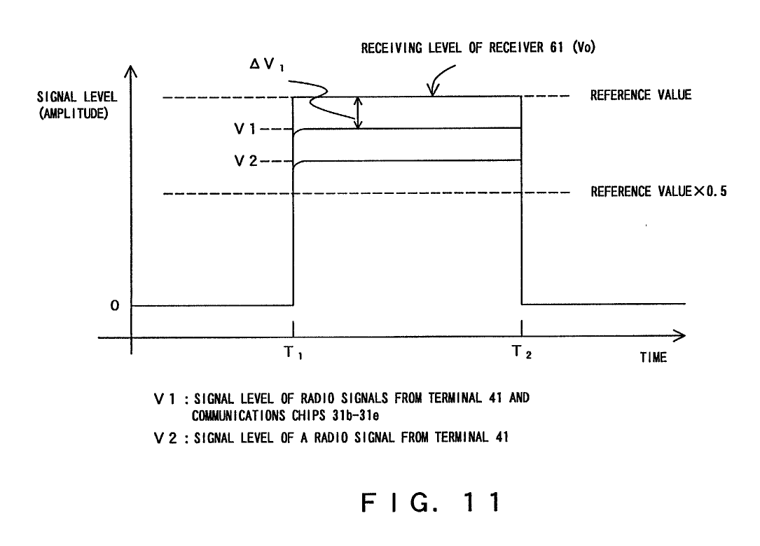

Next, the operation of the signal generation unit 53 is described in detail with reference to FIGS. 6 and 11. FIG. 11 shows the signal level of the communications chip 31a shown in FIG. 6. In this example, it is assumed that the terminal device 41 transmits radio signals between times T1 and T2 and stops the transmission after time T2.

Between times T1 and T2, at the communication chip 31a, the signal level V1 of radio signals from both the terminal device 41 and communications chips 31b-31e is lower than the signal level required by the radio network 11 (reference value). However, it is assumed that this signal level V1 is higher than a “reference value×0.5”. In this case, the feedback system of the communications chip 31a, which was described with reference to FIG. 9, controls the transmission level of the transmitter 65 in such a way that the receiving level V0 at the receiver 61 becomes the reference value. Specifically, the communications chip 31a outputs a radio signal with a signal level ΔV1.

The operation described above is performed in the same way in all communications chips 31 constituting the radio network 11. As a result, when the terminal device 41 starts transmitting radio signals, the receiving levels of the communications chips located in the vicinity of the terminal device 41 (in FIG. 6, communications chips 31a, 31b and 31d) exceed the “reference value×0.5” due to the radio signal directly from the terminal device 41. Therefore, these communications chips also output radio signals to compensate for the signal level of the respective radio signal.

The moment the terminal device 41 starts transmitting a radio signal, the receiving levels of the communications chips located far away from the terminal device 41 (in FIG. 6, communications chips 31c and 31e) do not exceed the “reference value×0.5” due to the radio signal directly from the terminal device 41. However, when the terminal device 41 starts transmitting a radio signal, the communications chips located near the terminal device 41 also start generating and outputting respective radio signals. Then, the communications chips located far away from the terminal device 41 start receiving not only the radio signal directly from the terminal device 41, but also the respective radio signals generated by the communications chips located in the vicinity of the terminal device 41, and the receiving levels of the communications chips located far away from the terminal device 41 also exceed the “reference value×0.5”. As a result, those communications chips also start operating to compensate for the signal levels of the respective radio signals.

In this way, the radio signals transmitted from the terminal device 41 are propagated all over the area of the radio network 11. Specifically, the radio network 11 functions as a space-shared bus.

When the terminal device 41 stops transmitting radio signals at time T2, the receiving level of the communications chip 31a instantaneously becomes “V0-V2”. If this receiving level (V0-V2) is lower than the “reference value×0.5”, the judgment unit 67 gives the stop instruction to the transmitter 65. In this way, the communications chip 31a stops outputting radio signals.

The operation described above is also performed in the same way in all the communications chips 31 constituting the radio network 11. As a result, all the communications chips constituting the radio network 11 stop outputting radio signals. A mechanism in which a transmission stoppage operation is propagated from a communications chip located in the vicinity of the terminal device 41 toward a communications chip located far away from the terminal device 41 is basically the same as that at the time of transmission start.

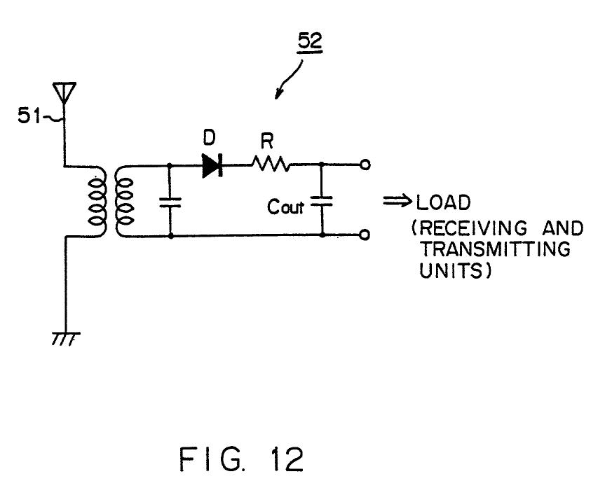

FIG. 12 is an example of the circuit diagram of the power generation unit 52. The power generation unit 52 converts electromagnetic waves received by the receiving chip antenna 51, including radiation from a fluorescent lamp, ripples of an AC power supply and radio signals, into electric energy. Specifically, the power generation unit 52 generates a current (for example, resonance current) from the received electromagnetic waves using a transformer, etc., and rectifies voltage caused by the current using a diode D. In this case, the current flowing through the diode D is introduced to a capacitor Cout via a resistor R. In this way, the capacitor Cout is charged. Then, this capacitor functions as a battery and supplies electric power to the signal generation unit 53.

Although in the example shown in FIG. 12, the resonance current is rectified by a half-wave rectification circuit, a full-wave rectification circuit can also be used instead of the half-wave rectification circuit if the power is insufficient. As is well known, the full-wave rectification circuit is formed by a bridge rectifier circuit which is composed of a plurality of diodes. It is also known that a full-wave rectification circuit can generate power more efficiently than a half-wave rectification circuit.

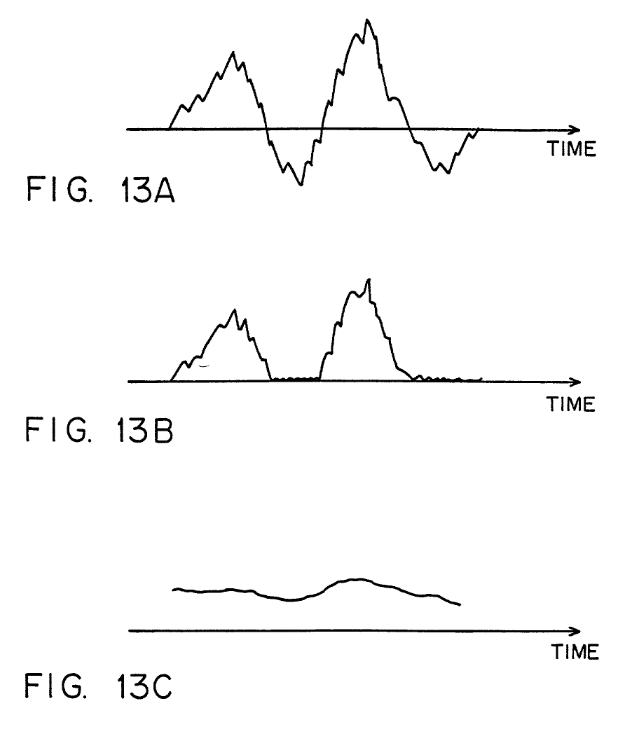

FIGS. 13A-13C show the operation of the power generation unit 53. FIG. 13A shows current flowing through a transformer. This current fluctuates violently due to the radiation noise of a fluorescent lamp. FIG. 13B shows current rectified by the diode D. FIG. 13C shows the voltage of the capacitor Cout charged by the current flowing through the diode D.

Although in the embodiment described above, power is generated from the energy of radio waves, power can also be generated from the energy of a magnetic field. For example, it is anticipated that a magnetic field in the vicinity or inside the fluorescent lamp fluctuates violently due to radiation noise. Here, as is well known, electromotive force can be obtained from the fluctuating magnetic field using an inductor. In this case, the communications chip31 generates power using the fluctuations of the magnetic field caused by noise radiated from the fluorescent lamp. In order to efficiently obtain energy from a magnetic field or obtain the stronger energy of a magnetic field, a one-turn antenna can also be adopted as an antenna provided in the communications chip 31.

The communications chip 31 in this example must be installed in a place with lots of noise, since power is to be generated using electromagnetic noise radiated from the fluorescent lamp. Therefore, a signal inputted to the signal generation unit 53 includes lots of noise (for example, common-mode noise).

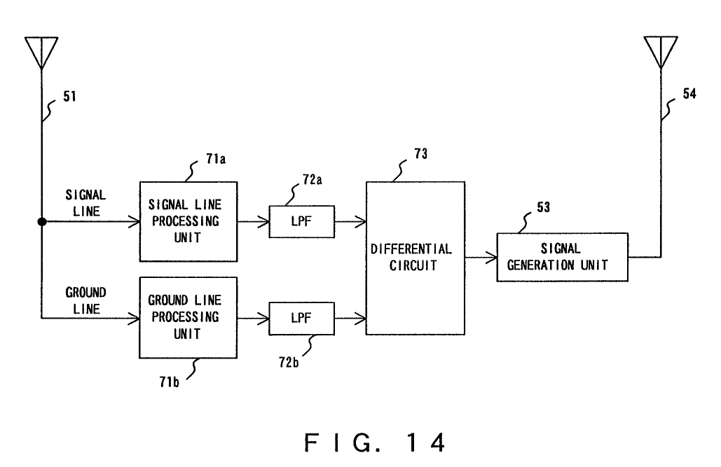

FIG. 14 shows the configuration of a communications chip provided with a circuit for eliminating common-mode noise. This communications chip comprises a signal line processing unit 71a, a ground line processing unit 71b and a differential circuit 73 as circuits for eliminating common-mode noise.

The signal line processing unit 71a and ground line processing unit 71b basically have the same configuration and terminate the signal line and ground line of the receiving chip antenna 51, respectively. The outputs of the signal line processing unit 71a and ground line processing unit 71b are passed through low-pass filters 72a and 72b, respectively, and are supplied to the differential circuit 73. The differential circuit 73 outputs a difference between them. In this way, noise in the signal line and ground line of the receiving chip antenna 51 are terminated in the same circuit and are cancelled by the difference circuit 73. Specifically, noise elements (common-mode noise, etc.) are eliminated from a signal to be outputted via the transmitting chip antenna 54.

The output of the differential circuit 73 is supplied to the signal generation unit 53 shown in FIG. 9. Then, the signal generation unit 53 outputs radio signals according to the processes described above, if required.

Next, the communication method using the radio communications system of this embodiment is described. In the following example, it is assumed that a gateway 12 manages and controls communications over a radio network 11.

The gateway 12 regularly transmits a radio signal including a frame signal in order to establish the synchronization of the radio network 11. This frame signal is transmitted, for example, using a signal of 13.5 MHz allowed as an ISM (Industrial Scientific Medical) band. A radio signal used to transmit the frame signal is transmitted with fairly high power (for example, at approximately a 1W level). Therefore, the radio signal used to transmit the frame signal can be transmitted directly to each terminal device accommodated in the radio network 11. In this way, each terminal device can be synchronized with one another by the frame signal in order to conduct data communications.

The radio network 11 provides a plurality of communications channels. The plurality of communications channels can be implemented, for example, by time-division multiplexing, frequency-division multiplexing or code-division multiplexing. A communications channel used by each terminal device is dynamically allocated by the gateway 12.

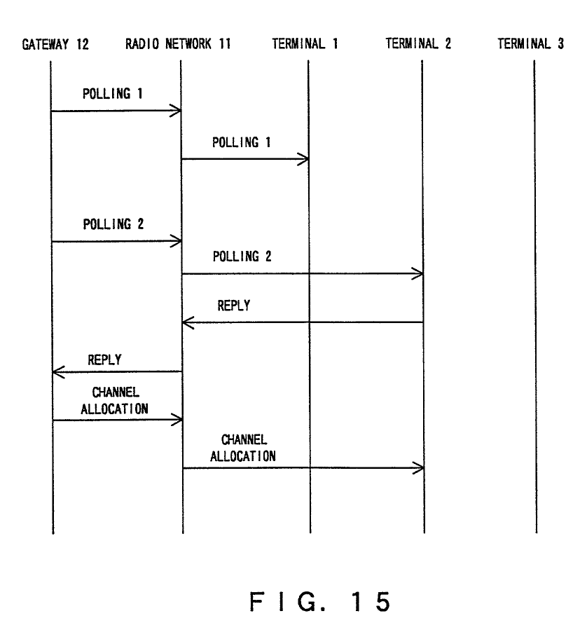

FIG. 15 is a sequence chart showing an operation of the gateway 12 to allocate a communications channel to a terminal device. In this example, a polling method is adopted.

The gateway 12 sequentially transmits a polling signal to all terminal devices accommodated in the radio network 11. This polling signal is transmitted over a weak wave, for example, in synchronization with a radio signal of 13.5 MHz, which is regularly outputted from the gateway 12.

In the example shown in FIG. 15, the gateway 12 first transmits a polling signal to a terminal 1. This radio signal, including the polling signal is transmitted via the radio network 11 and is received by the terminal 1. Actually, the frame signal and polling signal are transmitted to all terminals (terminals 1-3). However, only terminal 1 accepts the polling signal and the other terminals discard the polling signal. Then, if the terminal 1 wants to start communications, the terminal 1 returns a reply signal to the gateway 12. In this example, the terminal 1 does not return a reply signal.

Then, the gateway 12 transmits a polling signal to a terminal 2. In this example, it is assumed that the terminal 2 wants to start communications. In this case, the terminal 2 transmits a reply signal corresponding to the received polling signal. This reply signal is transmitted over the radio network 11 and is received by the gateway 12.

On receipt of this reply signal, the gateway 12 determines a communications channel to be allocated to the terminal 2 and notifies the terminal 2 of the channel. After this, the terminal 2 can use the notified channel. How to determine a communications channel to be allocated to a terminal device is described later.

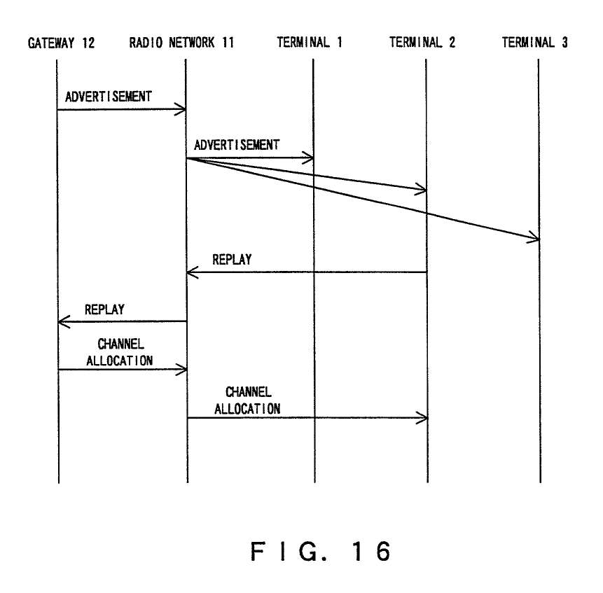

In the above example, when a communications channel is allocated to a terminal device, a polling method is used. However, the radio communications system of this embodiment is not limited to this method. FIG. 16 shows another allocation method.

In the method shown in FIG. 16, an advertisement message is used instead of a polling signal. This advertisement message is generated by the gateway 12 and is received by all the terminal devices accommodated in the radio network 11. This advertisement message is also transmitted, for example, in synchronization with the frame signal described above.

A radio signal, including the advertisement message is propagated over the radio network 11 and is received by terminals 1-3. In this case, any terminal that wants to start communications returns a reply signal to the gateway 12. In this example, the terminal 2 returns a reply signal. Here, the procedure for transmitting the reply signal to the gateway 12 and the procedure of allocating a communications channel to a terminal by the gateway 12 are the same as those shown in FIG. 15.

As described above, the radio network 11 provides a plurality of communications channels using one or more multiplex technologies. In this example, it is assumed that time-division, frequency-division and code-division multiplexing are used.

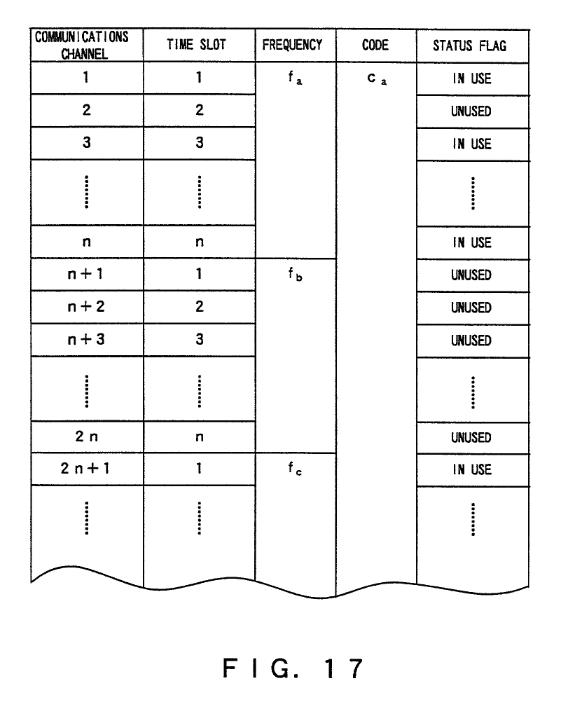

FIG. 17 shows a communications channel management table for managing communications channels. This table is provided in the gateway 12.

The communications channel management table manages a time slot, frequency and code to be used by each communications channel, and the status flag of each communications channel. A “time slot” is used to identify a time slot when a radio signal is time-division-multiplexed. This time slot is synchronized with the frame signal described above. A “frequency” is used to identify a frequency when a radio signal is frequency-division-multiplexed. A “code” is used to identify a code when a radio signal is code-division-multiplexed. In this case, the “code” means, for example, a spread code or a hopping pattern when spectrum spread method is introduced as a code-division multiplex method. In this example, it is assumed that a different code is used for each radio network 11. In this case, a code corresponding to a radio network managed by the relevant gateway is set in the communications channel management table of each gateway 12. A “status flag” indicates whether a communications channel is currently being used.

The gateway 12 refers to the communications channel management table described above and determines communications channels to be allocated to a terminal device accommodated in the radio network 11. Specifically, on receipt of a reply signal from a specific terminal device (see FIGS. 15 or 16), the gateway 12 refers to the communications channel management table and detects an unused communications channel. Then, the gateway 12 allocates the detected communications channel to the terminal device. Specifically, the gateway 12 notifies the terminal device of the respective time slot, frequency and code of the detected communications channel. Then, the notified terminal device can communicate using the allocated communications channel.

As described above, the radio communications system of this embodiment comprises a plurality of communications chips, and radio signals are propagated all over the area of the radio network 11 while these communications chips appropriately compensate for the signal levels. In this case, each communications chip basically receives radio signals generated by a plurality of other communications chips. Here, the plurality of radio signals from the different communication chips are basically different each other in transmission delay.

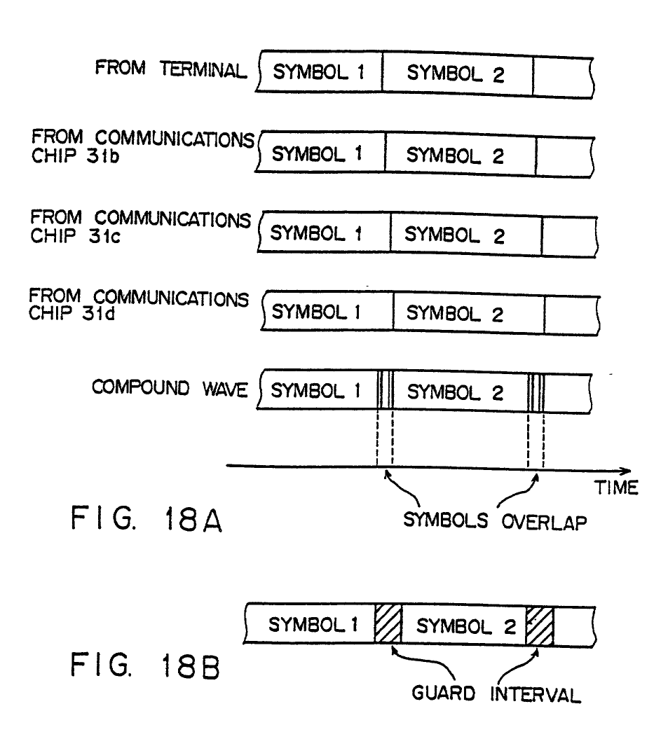

Therefore, the receiving timings of a plurality of radio signals by a specific communications chip are different, as shown in FIG. 18A. As a result, a symbol transmitted in a specific timing and a symbol transmitted in a subsequent timing are sometimes overlapped in the compound wave of these radio signals. If a plurality of symbols are overlapped, the symbols cannot be reproduced.

In this embodiment, as shown in FIG. 16B, a guard interval is provided in advance between the symbols of data transmitted/received between terminal devices (including the gateway 12) in order to solve this problem. The length of this guard interval is determined, for example, based on the delay time of each communications chip, the number of communications chips provided in the radio network 11, and so on. Specifically, for example, the guard interval is set in such a way that it becomes longer than a “period of time when symbols are overlapped”, as shown in FIG. 18A. In this way, each terminal device can reproduce symbol data transmitted by the radio signal without fail.

Although in the embodiment described above, it is assumed that the radio communications system 10 is introduced in an office or ordinary home, the present invention is not limited to this. For example, even when a radio network is established in an underground shopping center or in a train car, it is sufficient if fluorescent lamps, etc., in which a communications chip 31 is embedded are installed at a prescribed place.

If a radio network is established along a road, the communications chips can be installed on electric light poles or in electric lights. In this case, a plurality of sub-net, each of which is a radio network 11 consisting of numerous pico-nets, are consecutively establish, for example, every 50 to 100 meters. Here, for example, as shown in FIG. 1, a layer is provided between a gateway 12 provided for each sub-net and the IP network 20 to implement a hand-over function or roaming function. By such a function, the disconnection of communications (disconnection of a call or disconnection of a connection, etc.) can be avoided in a layer lower than the IP network 20. For such a function, for example, a function that is implemented in an existing PHS (Personal Handyphone System: one of a mobile communication system in Japan) network or cellular phone network (for example, a soft-handover function) can be used.

Even if a mobile terminal moves from the communications area of a specific sub-net to the communications area of another sub-net in such a configuration, the disconnection of communications can be avoided by a hand-over function or roaming function. As described above, one radio space-shared bus is established by a lot of communications chips in each sub-net. Therefore, even if the mobile terminal moves within a specific sub-net, neither hand-over nor roaming occurs and communications are never disconnected.

According to the present invention, a radio network is established by combining small pico-nets, the transmission rate of which can be easily improved. Therefore, a high-speed transmission can be implemented with low transmitting power. Since a radio communications device constituting a radio network is built inside mass-consumed products, the radio network can be established only by replacing the mass-consumed products with new ones. In other words, a radio network can be established very easily in a very short period of time. Furthermore, each of a plurality of radio communications devices constituting the radio network is provided with a power generation function. Therefore, no batteries or feeders are required and no substantial maintenance is required accordingly.

What is claimed is:

1. A radio communications system, including a plurality of radio communications devices, each of the radio communications devices comprising:
a receiving unit receiving a radio signal;
a detector detecting a difference between a predetermined reference level and a receiving level of the radio signal received by said receiving unit; and
a transmitting unit outputting a radio signal, which is same signal as that received by said receiving unit, at a transmitting level such that the difference detected by said detector is zero.

2. The radio communications system according to claim 1, further comprising
a server device distributing a software program to the plurality of radio communications devices, wherein
each of the radio communications device further comprises a storage unit storing the software program distributed by said server device, and a controller controlling an operation of the corresponding radio communications device according to the software program stored in the storage unit.

3. A radio communications system including a plurality of radio communications devices, wherein
each of the radio communications devices compensates for a signal level of a radio signal, and wherein
the plurality of radio communications devices provides a radio space-shared bus to propagate a radio signal from a terminal device all over a communications area established by the plurality of radio communications devices.

4. A radio communications system for establishing a high-speed radio access network, wherein
a plurality of pico-nets are provided, and wherein
transmitting power of each of the pico-nets is reduced to a level where no interference occurs between the plurality of pico-nets, and wherein
communication band of each of the pico-nets is broadened.

5. The radio communications system according to claim 4, wherein
one or more sub-nets are established by combining the plurality of pico-nets as a radio space-shared bus.

6. The radio communications system according to claim 5, further comprising
a connection controller connecting the plurality of sub-nets and providing the plurality of sub-nets with a roaming function or hand-over function.

7. The radio communications system according to claim 5, wherein
the roaming function or hand-over function is not provided to the plurality of pico-nets inside each sub-net.

8. The radio communications system according to claim 5, wherein
the plurality of sub-nets are divided in terms of frequency, time or code.

9. A gateway device installed in a sub-net of the radio communications system according to claim 5, comprising:
a frame signal provision unit providing a plurality of terminal devices accommodated in the relevant sub-net with a frame signal in order to synchronize radio signals;
a allocating unit allocating a communications channel provided by the radio space-shared bus to a terminal device accommodated in the relevant sub-net; and
a communications unit communicating with a terminal device accommodated in the relevant sub-net.

10. The gateway device according to claim 9, further comprising
an interface unit connecting the relevant radio network to another network.

11. A radio communications method for transmitting data using a radio communications system including a plurality of radio communications devices, comprising:
transmitting a radio signal from a first terminal device;
detecting by each of the radio communications device a receiving level of the radio signal;
outputting by each of the radio communication device a radio signal, which is same signal as the received signal, at a transmitting level such that the difference level detected by said detector is zero; and
receiving by a second terminal the radio signal from one or more radio communications devices among the plurality of radio communications devices.

12. A radio communications device used in a radio communications system including a plurality of radio communications devices, comprising:
a receiving unit receiving a radio signal;
a detector detecting a difference between a predetermined reference level and a receiving level of the radio signal received by said receiving unit; and
a transmitting unit outputting a radio signal, which is same signal as that received by said receiving unit, at a transmitting level such that the difference detected by said detector is zero.

13. The radio communications device according to claim 12, wherein
said detector comprises an integrator performing complete integral on the difference between the reference level and the receiving level, and
said transmitting unit outputs the radio signal based on the output of the integrator.

14. The radio communications device according to claim 12, further comprising
a judgment unit stopping an operation of the transmitting unit if the receiving level of the radio signal from a terminal device and other radio communications devices are lower than a predetermined threshold value.

15. The radio communications device according to claim 12, further comprising
a power generator generating power using at least one of temperature, light, noise and vibration in a vicinity of the relevant radio communications device, wherein
the power generated by said power generator is supplied to at least one of said receiving unit, detector and transmitting unit.

16. The radio communications device according to claim 12, further comprising
a power generator for generating power using electromagnetic noise radiated from a fluorescent lamp or ripples in AC voltage supplied to a fluorescent lamp, wherein
the power generated by the power generator is supplied to at least one of said receiving unit, detector and transmitting unit.

17. A radio communications device used in a radio communications system including a plurality of radio communications devices, comprising:
a receiving unit receiving a radio signal;
a pair of a signal line processing unit and a ground line processing unit that have the same configuration for processing the signal received by said receiving unit;
a differential circuit outputting a difference between output of the signal line processing unit and output of the ground line processing unit;
a detector detecting a difference between a predetermined reference level and an output of said differential circuit; and
a transmitting unit outputting a radio signal, which is same signal as that received by said receiving unit, at a transmitting level such that the output of said detector is zero.

18. A communications device, which is provided with a receiving antenna and a transmitting antenna, and outputs a signal via the transmitting antenna, a phase of which being same as that of a received signal, in order to compensate for a signal level in such a way that a receiving power of a received signal received via the receiving antenna becomes a predetermined reference value.

19. The communications device according to claim 18, wherein
a complete integral circuit is provided in a control loop for controlling transmitting signals.

20. The communications device according to claim 18, wherein
an operation of transmitting signals via the transmitting antenna is stopped if a receiving power of a signal received via the receiving antenna is lower than a predetermined reference value to judge whether there is a signal.

21. The communications device according to claim 18 comprises a generator to generate power using at least one of thermal energy, vibration energy, energy of an electric field noise and energy of a magnetic field noise existing in a vicinity of this communications device.

22. The communications device according to claim 18, wherein a radio signal transmitted via the transmitting antenna is weak.

23. The communications device according to claim 18, further comprising
a pair of signal line circuit and a ground line circuit terminating a signal received via the receiving antenna, wherein
a signal to be transmitted via the transmitting antenna is generated based on a difference between output of the two circuits.

24. A communications system including a plurality of communications devices, wherein
each of the communications device, provided with a receiving antenna and a transmitting antenna, outputs a signal via the transmitting antenna, a phase of which being same as that of a received signal, in order to compensate for a signal level in such a way that a receiving power of a received signal received via the receiving antenna becomes a predetermined reference value, and wherein
a space-shared bus is established by installing the plurality of communication chips at intervals of 10 meters or less.

25. The communications system according to claim 24, wherein
a sub-net is established by a plurality of pico-nets, and each of the pico-nets is provided by corresponding communications device with an access area of a radius of approximately 10 meters.

26. The communications system according to claim 24, wherein
transmitting power of each communications device is weak and a communications band in each pico-net is broad.

27. The communications system according to claim 24, wherein
each communications device is installed at or built in a mass-consumed product.

28. The communications system according to claim 24, wherein
each communications device receives a software program from an external device via a radio transmission line and executes the software program.

29. The communications system according to claim 25, wherein
the sub-net is provided with a gateway device and frame synchronization within the sub-net is established by a frame synchronization signal transmitted by the gateway.

30. The communications system according to claim 29, wherein
the gateway device allocates a communications channel to a terminal device accommodated in the sub-net managed by the relevant gateway device.

31. The communications system according to claim 29, wherein
a guard interval is provided by the frame synchronization signal.

32. The communications system according to claim 24, wherein
each communications device is installed at or built in a mass-consumed product, and generates power using at least one of thermal energy, vibration energy, energy of an electric noise and energy of a magnetic field noise, and receives a software program from an external device via a radio transmission line to execute it, and wherein
a gateway device connecting the space-shared bus to another network is provided.

33. A fluorescent lamp in which a radio communications device is installed, the radio communication device being used in a system including a plurality of radio communications devices, the radio communication device comprising:
a receiving unit receiving a radio signal;
a detector detecting a difference between a predetermined reference level and a receiving level of the radio signal received by said receiving unit; and
a transmitting unit outputting a radio signal, which is same signal as that received by said receiving unit, at a transmitting level such that the difference detected by said detector is zero.
